(19) United States
(12) Patent Application Publication
(10) Pub. No.: US 2024/0334899 A1
(43) Pub. Date: Oct. 10, 2024

(54) ANIMAL FEEDING BUCKET

(71) Applicants: Leslie P. Duke, Lindale, GA (US); Savannah G. Marion, Lindale, GA (US)

(72) Inventors: Leslie P. Duke, Lindale, GA (US); Savannah G. Marion, Lindale, GA (US)

(21) Appl. No.: 18/746,277

(22) Filed: Jun. 18, 2024

Related U.S. Application Data
(63) Continuation-in-part of application No. 18/379,417, filed on Oct. 12, 2023.
Application No. 18/379,417 is a continuation-in-part of application No. 17/236,321, filed on Apr. 21, 2021, now abandoned.

(51) Int. Cl. A01K 5/01

(52) U.S. Cl. CPC A01K 5/0107

(57) ABSTRACT

An animal feeding bucket includes a container, a locking system, and a base plate. The container has a top edge, a bottom, and sidewalls. The base plate has a peripheral rim with an interior surface and an exterior surface. The locking system includes a first locking member coupled to the base plate interior surface, a second locking member coupled to the container bottom, a third locking member coupled to the base plate exterior surface, and a fourth locking member coupled to the container top edge. The base plate may be used as a base when the first locking member is coupled with the second locking member, or used as a lid when the third locking member is coupled with the fourth locking member.

### CROSS REFERENCE TO RELATED APPLICATIONS

This is a continuation-in-part of U.S. patent application Ser. No. 18/379,417 filed Oct. 12, 2023 and entitled Animal Feeding Bucket, which is a continuation-in-part of U.S. patent application Ser. No. 17/236,321 filed on Apr. 21, 2021 and entitled Animal Feeding Bucket.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present inventive concept relates to the field of an animal feeders. More particularly, the invention relates to a portable animal feeding bucket.

### Technology in the Field of the Invention

The owner of large animals, such as horses, cattle, goats or sheep, must feed their animals on a daily basis. These animals typically eat gain, or the like, that is delivered to the feeding site in buckets. These buckets of feed, or water, may vary in size and shape. The bucket may be simply placed upon the ground so that the animal may feed from the open top of the bucket.

A larger problem related to the use of feeding buckets is that the animal or animals may tip over the bucket during the feeding process, the chances of which increase when several animals are eating from the same feeding bucket. Also, the animal may accidently step on a bucket, causing it to tip over and spread the feed or water upon the ground.

Another problem with feeding buckets is that if they are made too sturdy a horse or other large animal may injure itself should it accidentally step on the bucket, thereby causing it to fall or strike the animal's legs.

Accordingly, a need exists for an animal feeder that may maintain a bucket of feed or water upright while allowing unencumbered access for the animal. It is to the provision of such therefore that the present invention is primarily directed.

### BRIEF SUMMARY OF THE INVENTION

An animal feeding bucket comprises a container for holding a volume of animal feed or water, a base plate, and a lock releasably securing the container to the base plate.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an animal feeding bucket embodying principles of the invention in a preferred form.

FIG. 2 is an exploded, perspective view of the animal feeding bucket of FIG. 1.

FIG. 3 is a partial cross-sectional view of a portion of an animal feeding bucket embodying principles of the invention in another preferred form.

FIG. 4 is a partial cross-sectional view of a portion of an animal feeding bucket embodying principles of the invention in another preferred form.

FIG. 5 is a cross-sectional view of a portion of an animal feeding bucket embodying principles of the invention in another preferred form.

FIG. 6 is a perspective view of an animal feeding bucked embodying principles of the invention in yet another preferred form, shown with two base plates in both a lid position and a base position.

FIG. 7 is an exploded, perspective view of the animal feeding bucket of FIG. 1, shown with two base plates in both a lid position and a base position.

FIG. 8 is a cross-sectional view of a portion of the animal feeding bucket of FIG. 6.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown an animal feeding bucket 10 in a preferred form of the present invention. The animal feeding bucket 10 includes a main bucket, pale, or container 12, a coupler or locking system 14, and a base plate or platform 16. The bucket is configured to hold large quantities of water or food with enough capacity for feeding a large animal, as opposed to small cups, bowls or the like intended to liquids or food for human consumption.

The container 12 has a top edge 18, a bottom or floor 20, and sidewalls 22 extending between the bottom 20 and top edge 18. A pivoting carrying handle 24 may be mounted to the sidewalls 22 adjacent the top edge 18. The container 12 is specifically configured to contain animal feed, water, or other substances, herein referred collectively as animal feed F.

The base plate 16 is generally circular with a diameter equal to or greater than the diameter of the container 12 at the top edge 18. The base plate 16 includes a plurality of spike holes 28 extending therethrough from a top surface 30. The base plate 16 also includes a plurality of mounting spikes 32. Each mounting spike has an elongated shaft 34 and a head 36 at one end of the shaft 34. The elongated shaft 34 is configured to pass through spike hole 28, while the head 36 is configured to be larger than the spike hole 28 so that it does not pass through the spike hole 28, i.e., the head 36 abuts the top surface of the base plate 16.

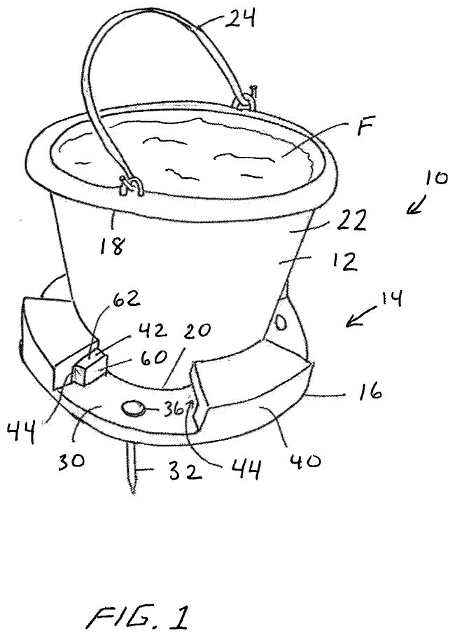

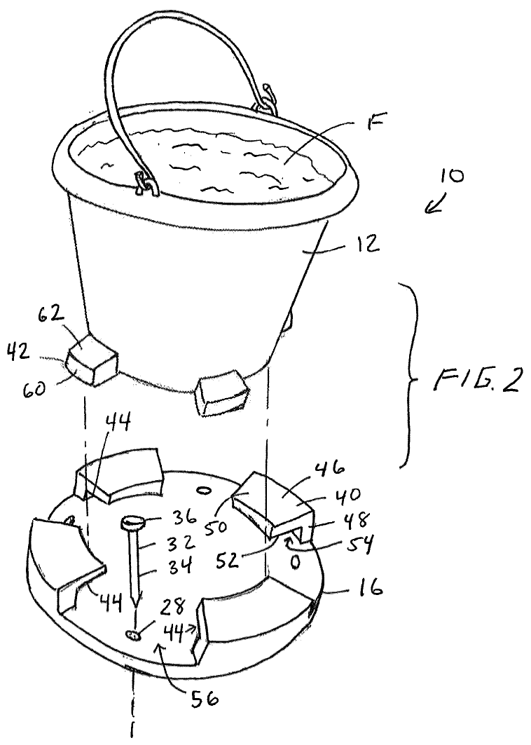

The locking system 14 includes a female or first locking member 40 coupled to the top surface 30 of the base plate 16 and a second locking member 42 coupled to the bottom 20 of the container 12. The first locking member 40 is configured to mate or mesh with the male or second locking member 42 for movement between a locked position, shown in FIG. 1, and an unlocked position, shown in FIG. 2. It should be noted that the female locking member 40 has two oppositely disposed open ends 44 which allow debris residing within the space between the first locking member 40 and the base plate 16 to be removed by either manually pushing the debris out of one open end 44 with a person's finger or by pushing debris out by rotating the second locking member 42 through the space. As such, dirt or mud from the animal's environment that becomes stuck to the mounting plate or tabs won't interfere or cause binding with the locking of the container 12 as it is easily and quickly removed.

The first locking member 40 has four inverted L-shaped locking catches or flanges 46. Each locking flange 46 has an upright or vertical wall 48 and an inwardly extending top wall 50. The bottom surface 52 of each top wall 50 is set at a declining angle or slope in a clockwise direction. The locking flanges 46 in combination with the base plate 16 define lock recesses 54 below the top walls 50. An entrance space 56 is positioned between each adjacent pair of locking flanges 46.

The second locking member 42 has four radially and outwardly extending locking ears, flanges, or tabs 60. Each locking tab 60 is configured to be received within entrance space 56 and be rotated into the lock recess 54 of one locking flange 46. The top surface 62 of the locking tab 60 is set at a declining angle or slope in a clockwise direction. The slope of the top surface 62 is approximately equal to the slope of the bottom surface 58 of the top wall 50, so that the locking tabs 60 and locking flanges 46 act as a cam and cam follower of a camming system that tightens the locking flange 46 of the first locking member 40 against the locking tabs 60 of the second locking member 42 through clockwise rotation of the second locking member 42.

All components of the animal feeding bucket 10 may be made of any conventional material used to form such containers, such as metal, plastic, wood, or the like.

In use, the base plate 16 may be set upon the ground at the preferred location of feeding and the mounting spikes 32 are slid though the spike holes 28 and forced into the underlying ground until the mounting spike heads 36 abut the base plate 16. Thus, the spikes firmly mount the base plate 16 to the ground.

An amount, volume, or mass of animal feed, water, or other material F may be placed within the container 12. The container 12 is then securely locked onto the base plate 16 utilizing the locking system 14. To do so, the container 12 is lowered until the locking tabs 60 are positioned within the entrance spaces 56 between adjacent locking flanges 46. The container 12 is then rotated in the clockwise direction so that the locking tabs 60 rotatably move into the lock recesses 54 below the locking flanges 46. The container 12 is rotated until the cooperation between the sloping bottom surface 52 of the locking flanges top wall 50 and the top surface 62 of the locking tabs 60 snugly interlocks the first locking member 40 with the second locking member 42, i.e., the first locking member 40 is locked to the second locking member 42.

With the container 12 locked to the base plate 16, the container 12 resists being tipped over or moved through contact with a feeding animal by the expanded diameter of the base plate 16 compared to the bottom of the container 12. Furthermore, the container 12 is resistant to tipping through the anchoring of the animal feeding bucket 10 through the mounting spikes 32 passing through the base plate 16 and into the underlying ground.

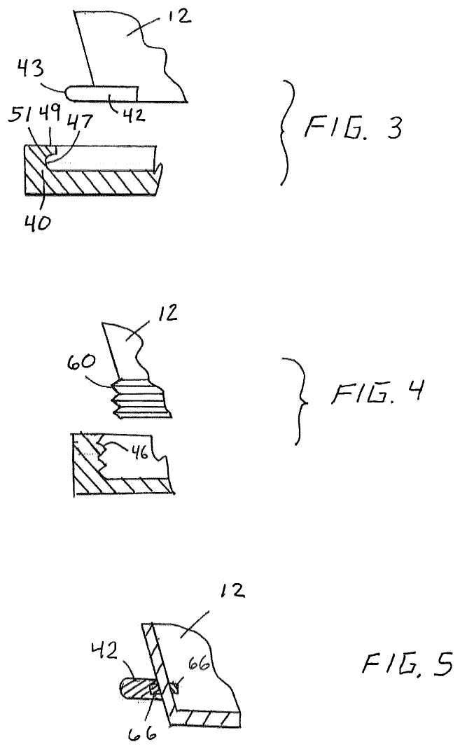

The second locking member 42 may be designed to break off or breakaway from the remaining container 12 should an animal strike or step upon the container with a striking force that may cause harm to the animal by causing it to trip, fall or become entangled with the container 12. The striking force may be considered a force that is not a rotational movement between the container 12 and the base plate 16 that is sufficiently large so as to cause the unwanted separation between the container and the base plate 16. This break away feature may be achieved by scoring the second locking member 42, thinning a portion of the second locking member 42, or the like. Similarly, either the first or second locking members may be held in position through magnets 66, as shown in FIG. 5. With this construction, the breakaway locking members may be put back in place through magnetic attraction after being dislodged by an animal forcibly contacting the animal feeding bucket.

As shown in FIG. 3, the peripheral edge or outer end of the second locking mechanism 42 may include rounded ends 43 (vertically rounded in cross-section) while the first locking mechanism 40 includes a corresponding rounded interior groove 47 (vertically rounded in cross-section) or interior end wall 51. Here the top ledge 49 of the first locking mechanism is also shortened so that if enough pressure is applied to the container 12, the second locking mechanisms 42 will pop out of the groove 47 of the first locking mechanisms to quickly release the container 12 from the plate 16. Once the container is removed, it may be reinserted through the normal twisting action between the first and second locking mechanisms. This quick releasing of the container allows for a breakaway feature of the bucket to prevent harm to the animal should the container 12 receive a striking force from the animal, as previously described.

It should be understood that as an alternative to the removable spikes 32, the base plate 16 may include spikes that are permanently affixed to extend downwardly from the base plate 16.

It should be understood that other types of coupling or locking means may be used as an alternative to the cooperating locking tabs 60 and locking flange 46 arrangement shown in the drawings. For example, the locking tabs bay be in the form of helical threads, as shown in FIG. 4. Also, it should be understood that the positioning of the locking tabs 60 and locking flanges may be reversed, so that the locking tabs 60 are positioned on the base plate 16 and the locking flanges 46 are positioned on the container 12.

It should be understood that as an alternative to the spikes 32, the base plate 16 may include other types of fasteners, such as bolts or screws, or other types of fasteners, which may be used to mount the base plate 16 to a stationary object such as a shelf, beam, floor, or bracket.

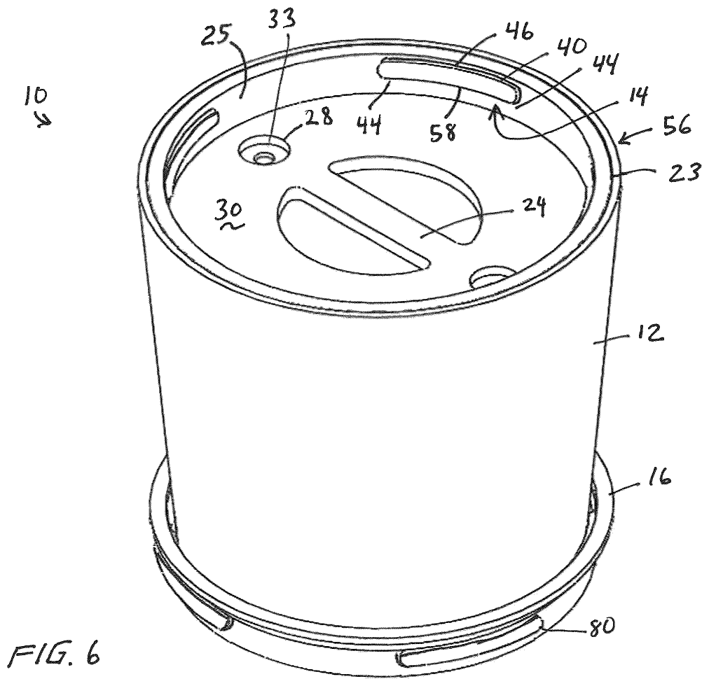

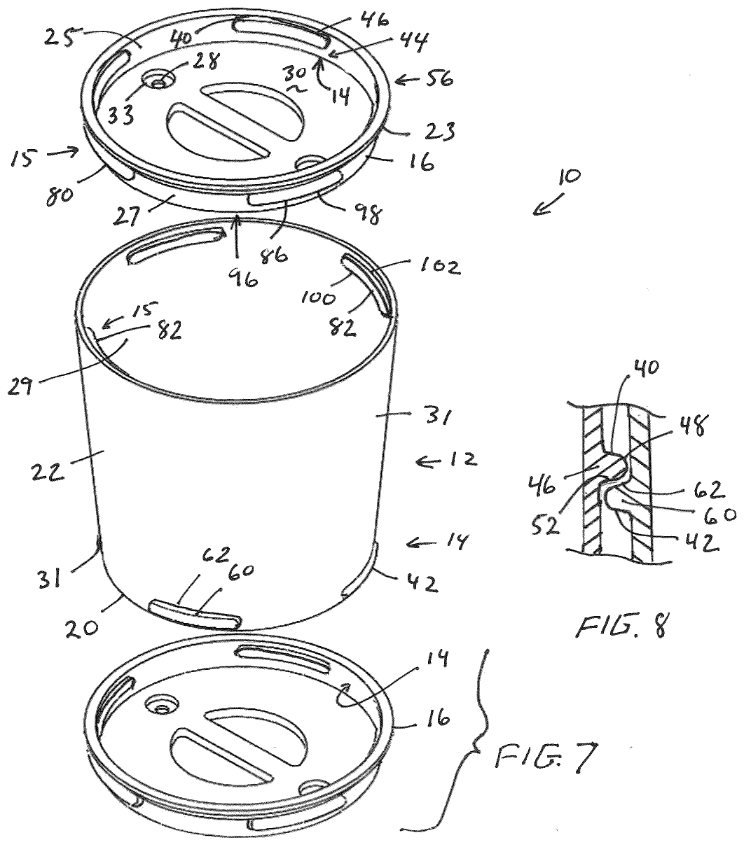

With reference next to FIGS. 6 and 7 of the drawings, there is a shown an animal feeding bucket 10 in a preferred form of the present invention. The animal feeding bucket 10 includes a main bucket, pale, or container 12, a base, base plate, platform or lid 16, an interior or internal coupler or locking system 14 that couples the base plate 16 to the bottom of the container 12, and an exterior or external locking system 15 that coupled the base plate (lid) 16 to the top opening of the container 12. The bucket 10 is configured to hold large quantities of water or food with enough capacity for feeding a large animal, as opposed to small cups, bowls or the like intended to liquids or food for human consumption. As used throughout, the terms interior and internal may be used interchangeably, similarly, the terms exterior and external may be used interchangeably.

The container 12 has a top edge 18, a bottom or floor 20, and tapered sidewalls 22 extending between the bottom 20 and top edge 18. The sidewalls 22 have an interior surface 29 and an exterior surface 31. The container 12 is specifically configured to contain animal feed, water, or other substances, herein referred collectively as animal feed F.

The base plate 16 is generally circular with a raised peripheral rim 23 having an interior rim surface 25 and an exterior rim surface 27. The base plate 16 includes a plurality of countersunk spike holes 28 extending therethrough from a top surface 30. Each spike hole 28 may include a rubber grommet 33 which acts as a seal. The base plate 16 also includes a plurality of mounting spikes similar to those previously identified. Each mounting spike has an elongated shaft and a head at one end of the shaft. The elongated shaft is configured to pass through spike hole 28, while the head is configured to be larger than the spike hole 28 but smaller than the countersunk portion of the spike hole 28, so that it does not pass through the spike hole 28 but rests below the top surfaces of the countersunk portion of the base plate 16. The base plate 16 also has a recessed handle 24.

The internal locking system 14 includes a plurality of internal female or first locking members 40 coupled to the interior rim surface 25 of the base plate 16 and a plurality of internal male or second locking members 42 coupled to the exterior surface 31 of the container 12 adjacent the bottom 20. Each internal first locking member 40 is configured to mate or mesh with a corresponding internal second locking member 42 for movement between a locked position and an unlocked position of the base plate 16 upon the bottom of the container 12. It should be noted that the internal first locking members 40 have two oppositely disposed open ends 44 which allow debris residing within the space between the internal first locking members 40 and the base plate rim 23 to be removed by either manually pushing the debris out of one open end 44 with a person's finger or by pushing debris out by rotating the internal second locking member 42 through the space. The internal second locking members 42 also have similar open ends. As such, dirt or mud from the animal's environment that becomes stuck to the mounting plate or locking members won't interfere or cause binding with the locking of the container 12 as the dirt is easily and quickly removed.

The internal first locking members 40 may have rounded locking rails, tabs, bars, catches or flanges 46 to allow easy disengagement should a striking force bit the animal feeding bucket 10. Each locking flange 46 is set at an inclining angle or slope in a clockwise direction. An entrance space 56 is positioned between each adjacent pair of locking flanges 46.

The internal second locking member 42 has a plurality of radially and outwardly extending internal locking rails, flanges, bars, catches, or tabs 60 extending from the exterior surface 31 adjacent the bottom 20 of the container 12. The internal locking tabs 60 may also be rounded. Each internal locking tab 60 is configured to be received within entrance space 56 and be rotated into engagement with and below the corresponding flanges 46 of the internal first locking members 40. The top surface 62 of the locking tabs 60 are set at an inclining angle or slope in a clockwise direction. The slope of the top surface 62 is approximately equal to the slope of the bottom surface 58 of the flanges 46, so that the locking tabs 60 and locking flanges 46 act as a cam and cam follower of a camming system that tightens the locking flange 46 of the internal first locking member 40 against the locking tabs 60 of the internal second locking member 42 through clockwise rotation of the internal second locking member 42 relative to the internal first locking member 40 when the base plate 16 is acting as a base plate coupled to the bottom 20 of the container 12.

The external locking system 15 includes a plurality of external female or third locking members 80 coupled to the exterior rim surface 27 of the base plate 16 and a plurality of external male or fourth locking members 82 coupled to the interior surface 29 of the container 12 adjacent the top edge 18. Each external third locking member 80 is configured to mate or mesh with a corresponding external fourth locking member 82 for movement between a locked position and an unlocked position of the base plate 16 (now acting as a lid) upon the top opening of the container 12. It should be noted that the external third locking members 80 and external fourth locking members 82 have two oppositely disposed open ends which allow debris residing within the space between the external third locking members 80 and the base plate rim 23 and/or between the external fourth locking members 82 and the interior surface 29 to be removed by either manually pushing the debris out of one open end with a person's finger or by pushing debris out by rotating the external fourth locking member 82 through the space. As such, dirt or mud from the animal's environment that becomes stuck to the mounting plate or locking members won't interfere or cause binding with the locking of the container 12 as the dirt is easily and quickly removed.

The external third locking members 80 have rounded locking bars, tabs, rails, catches or flanges 86. Each locking flange 86 is set at a declining angle or slope in a clockwise direction. An entrance space 96 is positioned between each adjacent pair of locking flanges 86.

The external fourth locking member 82 has a plurality of radially and outwardly extending rounded external locking rails, bars, catches, flanges, or tabs 100. Each external locking tab 100 is configured to be received within entrance space 96 and be rotated into engagement with and below the corresponding flanges 86 of the external third locking members 80. The top surface 102 of the locking tabs 100 are set at a declining angle or slope in a clockwise direction. The slope of the top surface 102 is approximately equal to the slope of the bottom surface 98 of the flanges 86, so that the locking tabs 100 and locking flanges 86 act as a cam and cam follower of a camming system that tightens the locking flange 86 of the external third locking member 80 against the locking tabs 100 of the external fourth locking member 82 through clockwise rotation of the external fourth locking member 82 when the base plate 16 is acting as a lid or cover with the top opening of the container 12.

It should be understood that the configuration of the first, second, third and fourth locking members may take on any conventionally known form. For example, the corresponding pair of these locking members may be in the form of a tongue and groove arrangement as shown in FIG. 3, a threaded arrangement as shown in FIG. 4, a magnetic arrangement as shown in FIG. 5, or any similar type of arrangement.

All components of the animal feeding bucket 10 may be made of any conventional material used to form such containers, such as metal, plastic, wood, or the like.

In use, the base plate 16 may be removable coupled to the bottom of the container 12 as previously described with the locking tabs 60 rotated in the counter-clockwise direction so that the locking tabs 60 rotatably cooperate with the locking flanges 46. The container 12 is rotated until the cooperation between the sloping bottom surface 52 of the locking flanges top wall 50 and the top surface 62 of the locking tabs 60 snugly interlocks the internal first locking member 40 with the internal second locking member 42, i.e., the internal first locking member 40 is locked to the internal second locking member 42.

With the container 12 locked to the base plate 16, the container 12 resists being tipped over or moved through contact with a feeding animal by the expanded diameter of the base plate 16 compared to the bottom of the container 12. Furthermore, the container 12 is resistant to tipping through the anchoring of the animal feeding bucket 10 through the mounting spikes 32 passing through the base plate 16 and into the underlying ground.

Again, the internal second locking members 42 may be designed to break off or breakaway from the remaining container 12 should an animal strike or step upon the container with a striking force that may cause harm to the animal by causing it to trip, fall or become entangled with the container 12. The striking force may be considered a force that is not a rotational movement between the container 12 and the base plate 16 that is sufficiently large so as to cause the unwanted separation between the container and the base plate 16. This break away feature may be achieved by scoring the internal second locking member 42. Similarly, either the internal first or second locking members may be held in position through magnets 66, as shown in FIG. 5. With this construction, the breakaway locking members may be put back in place through magnetic attraction after being dislodged by an animal forcibly contacting the animal feeding bucket. Also, the internal first or second locking members (as well as similarly configured third and fourth locking members) may be rounded to allow for the release of the members from each other, as shown in FIG. 8.

Alternatively or additionally, the base plate 16, or a second base plate 16, may be removable coupled to the top or top opening of the container 12. Here, with the locking tabs 100 rotated in the clockwise direction so that the locking tabs 100 are rotatably cooperate with the locking flanges 86. The container 12 is rotated until the cooperation between the sloping bottom surface 98 of the locking flanges 86 and the top surface 102 of the locking tabs 100 snugly interlocks the external third locking member 80 with the external fourth locking member 82, i.e., the external third locking member 80 is locked to the external fourth locking member 82. Thus, the rotatable direction associated with the locking of the base plate to the bottom of the container is in the opposite direction associated with the locking of the base plate to the top of the container when acting as a lid.

Thus, it should be appreciated that the base plate 16 may act as both the lid of a container and the base plate of a container through the cooperation of two different sets of couplers or locking systems. This dual purpose of the base plate 16 reduces the cost of the product as only one plate or item need be manufactured for both purposes. This dual purpose feature also allows one to securely carry feed to a location with the lid preventing contaminants from entering the feed, while also restricting tipping through the use of a base plate when in use for feeding.

It should be understood that the inclining angle of the internal first locking member 40 and internal second locking member are oriented in a direction or angle opposite to the declining direction, in the clockwise direction, of the external third locking member 80 and external fourth locking member 82. This configuration provides for an easier coupling and uncoupling of a first or lower base plate 16 to the bottom 20 of the container 12 through the coupling and uncoupling of a second or upper base plate 16 to the top edge 18 of the container. For example, the container 12 may be positioned upon a lower base plate 16 with the internal second locking members 42 positioned within the entrance spaces 56 of the lower base plate 16. With a second or upper base plate 16 already secured to the top edge 18 of the container 12 through engagement of the external third locking members 80 with the external fourth locking members 82, a person may grasp handle 24 of the upper base plate and rotate the upper base plate 16 in a counter-clockwise direction which causes the container 12 secured to the upper base plate 16 to also rotate in a counter-clockwise direction. This counter-clockwise rotation of the container 12 causes the internal first locking members 40 to bear against the internal second locking members 42 until the container 12 is fully locked with the lower base plate 16. The opposite inclining direction of the first and second locking members 40 and 42 to that of the third and fourth locking members 80 and 82 causes the tightening of the upper/second base plate 12 while simultaneously causing the loosening of the lower/first base plate 12 when rotated in a counter-clockwise direction.

When the upper/second base plate 12 is moved in a clockwise direction, the upper/second base plate 12 maintains its locked position to the container 12 while simultaneously causing the internal second locking members 42 to move relative to the internal first locking member 40 until the container 12 is released from the lower/first base plate 12. The container 12 with the upper/second base plate 12 still attached thereto may then be carried away by the person grasping the handle 24 of the upper/second base plate 12 acting as a lid.

It should also be understood that the present invention provides the benefit on having an animal feeding bucket that does not include a handle when in use. When the upper/second base plate 16 is removed from the container 12 to provide animal access to the feed F therein, the animal feeding bucket 10 does not include a handle that may cause the animal's foot to become entangled. This lack of a handle, or the providing of a removable handle, allows a greater amount of safety associated with the animal feeding bucket 10.

It will be appreciated that the inventions are susceptible to modification, variation and change without departing from the spirit thereof.

1. An animal feeding bucket comprising:
a container for holding a volume of animal feed or water, the container having a bottom and an open top;
a base plate having a width larger than the width of said container bottom, said base plate having a peripheral rim with an interior surface and an exterior surface oppositely disposed from said interior surface, and
a first coupler releasably for securing said base plate to a bottom portion of said container, and
a second coupler releasably for securing said base plate to a top portion of said container to close said open top.

2. The animal feeding bucket of claim 1 wherein said first coupler is associated with said interior surface of said rim of said base plate, and wherein said second coupler is associated with said exterior surface of said rim of said base plate.

3. The animal feeding bucket of claim 2 wherein said first coupler includes a plurality of radially extending first locking members associated with said interior surface of said rim of said base plate and a plurality of second locking members associated with an exterior surface of said container.

4. The animal feeding bucket of claim 3 wherein said second coupler includes a plurality of radially extending third locking members associated with said exterior surface of said rim of said base plate and a plurality of fourth locking members associated with a top end of said container.

5. The animal feeding bucket of claim 3 wherein either said first locking member or said second locking member is configured to break away should a striking force be applied to the container.

6. The animal feeding bucket of claim 3 wherein each said first locking members includes an open entrance and an open exit so that unwanted debris within the first locking members may be forced out of the open exit through passage of the second locking members through said first locking member.

7. The animal feeding bucket of claim 3 wherein either said first locking member or said second locking member has vertically rounded peripheral edge,
whereby the rounded peripheral edges provide for a release of the container from the base plate.

8. The animal feeding bucket of claim 3 wherein each said first locking member includes at least one first magnetic portion, and wherein said second locking member includes at least one second magnetic portion that is magnetically attracted to said first magnetic portion to provide a releasable mounting of said first locking members to said second locking member.

9. The animal feeding bucket of claim 3 wherein said plurality of first locking members includes helical threads, and wherein said plurality of second locking members includes helical grooves.

10. The animal feeding bucket of claim 1 wherein said base plate includes a handle portion.

11. The animal feeding bucket of claim 3 wherein said first locking members are elongated first flanges that are oriented at an inclining angle in a select rotational direction, wherein said second locking members are elongated second flanges that are oriented at an inclining angle in the select rotational direction.

12. The animal feeding bucket of claim 11 wherein said third locking members are elongated third flanges that are oriented at a declining angle in the selected rotational direction, and wherein said fourth locking members are elongated fourth flanges that are oriented at a declining angle in the selected rotational direction.

13. The animal feeding bucket of claim 7 wherein both said first locking member and said second locking member have vertically rounded peripheral edges,
whereby the rounded peripheral edges provide for a release of the container from the base plate.

14. An animal feeding bucket comprising:
a container for holding a volume of animal feed or water, the container having a bottom and an open top;
a base plate having a peripheral rim with an interior surface configured to conform with said bottom of said container and an exterior surface oppositely disposed from said interior surface configured to conform with said open top of said container, and
a first coupler releasably securing said base plate to a bottom portion of said container, and
a second coupler releasably securing said base plate to a top portion of said container to close said open top.

15. The animal feeding bucket of claim 14 wherein said first coupler is associated with said interior surface of said rim of said base plate, and wherein said second coupler is associated with said exterior surface of said rim of said base plate.

16. The animal feeding bucket of claim 15 wherein said first coupler includes a plurality of radially extending first locking members associated with said interior surface of said rim of said base plate and a plurality of second locking members associated with an exterior surface of said container.

17. The animal feeding bucket of claim 16 wherein said second coupler includes a plurality of radially extending third locking members associated with said exterior surface of said rim of said base plate and a plurality of fourth locking members associated with a top end of said container.

18. The animal feeding bucket of claim 16 wherein either said first locking member or said second locking member is configured to break away should a striking force be applied to the container.

19. The animal feeding bucket of claim 16 wherein each said first locking members includes an open entrance and an open exit so that unwanted debris within the first locking members may be forced out of the open exit through passage of the second locking members through said first locking member.

20. The animal feeding bucket of claim 16 wherein either said first locking member or said second locking member has vertically rounded peripheral edge, whereby the rounded peripheral edges provide for a release of the container from the base plate.

21. The animal feeding bucket of claim 16 wherein each said first locking member includes at least one first magnetic portion, and wherein said second locking member includes at least one second magnetic portion that is magnetically attracted to said first magnetic portion to provide a releasable mounting of said first locking members to said second locking member.

22. The animal feeding bucket of claim 16 wherein said plurality of first locking members includes helical threads, and wherein said plurality of second locking members includes helical grooves.

23. The animal feeding bucket of claim 14 wherein said base plate includes a handle portion.

24. The animal feeding bucket of claim 16 wherein said first locking members are elongated first flanges that are oriented at an inclining angle in a select rotational direction, wherein said second locking members are elongated second flanges that are oriented at an inclining angle in the select rotational direction.

25. The animal feeding bucket of claim 24 wherein said third locking members are elongated third flanges that are oriented at a declining angle in the selected rotational direction, and wherein said fourth locking members are elongated fourth flanges that are oriented at a declining angle in the selected rotational direction.

26. The animal feeding bucket of claim 20 wherein both said first locking member and said second locking member have vertically rounded peripheral edges, whereby the rounded peripheral edges provide for a release of the container from the base plate.
